(19) United States
(12) Patent Application Publication
(10) Pub. No.: US 2012/0089539 A1
(43) Pub. Date: Apr. 12, 2012

(54) BUSINESS METHOD FOR DISCOUNT SYSTEM CREATION AND MARKETING

(75) Inventors: Rafael GAZETOV, Visaginas (LT); Vitalij GLUSCENKO, Visaginas (LT); Jurijs MISCENKO, Daugavpils (LV); Jurijs SABANSKIS, Daugavpils (LV)

(73) Assignee: UAB "IEEC", Vilnius (LT)

(21) Appl. No.: 12/899,633

(22) Filed: Oct. 7, 2010

(51) Int. Cl. G06Q 90/00

(52) U.S. Cl. 705/500

(57) ABSTRACT

A business method for creating a discount system and marketing includes: establishing an Executor by the Organizer; requesting Customer products or services, and receiving discount from the Executor or Organizer on purchased products and services; uniting Customers or Suppliers into a community; requesting discounts from the Supplier in exchange for turning Customers into clients; Granting discounts by the Supplier on sold products and services; Turning members of the community, headed by the Executor or the Organizer, into clients of the given Supplier of products and services; granting discounts by the Executor or the Organizer to each member of the community on products and services sold by the Supplier; delivering products and services by the Supplier directly to each Customer for prices lowered for the amount of the directed discount; purchasing products and services by each Customer from the Supplier directly for prices lowered for the amount of the directed discount.

### FIELD OF THE INVENTION

The present invention can be widely used in trading and other economic spheres and it relates to the field of creation of the competitive environment in economy and improvement of competitiveness of Suppliers of products and services in the market.

### BACKGROUND

In traditional commerce, there is relationship between two participants, namely, between Suppliers (sellers) of products and services and their Customers, who come to an agreement on granting certain discounts on the products or services, and conditions of granting the discounts and sizes of the discounts are defined by means of negotiations between them, or the seller unilaterally provides discount to the Customer and informs the Customer about it.

Thus, there is an unorganized market of discounts on products and services, where the size of discounts on certain products and services varies and depends only on arrangements between the supplier of products and services and the Customer.

### SUMMARY OF THE INVENTION

In the present invention, creation of discount system is performed according to the following algorithm:
Assigning or creating (establishing) of the Executor (Executors) by the Organizer;
Making requests on behalf of the Organizer or the Executor to the Customer or Customers of products or services with objective of being united in the Community headed by the Executor or the Organizer, and receiving directed Discount from the Executor or the Organizer on the purchased products and services;
Uniting, via computer, telecommunication system or other means, Customers or Suppliers of products or services into the Community headed by the Executor or the Organizer, for example, association, public organization or other legal entities;
Making requests on behalf of the Organizer or the Executor to the Supplier of products and services with objective of granting overall Discount to the Executor or the Organizer on the sold products and services in exchange for turning Customers (members of the Community, headed by the Executor or the Organizer) into clients of this Supplier;
Turning of Customers (members of the Community, headed by the Executor or the Organizer) into clients of the Supplier which provides overall Discount to the Executor or the Organizer;
Granting of overall Discount by the Supplier of products and services to the Executor or the Organizer on sold products and services; Turning of members of the Community, headed by the Executor or the Organizer, into clients of the given Supplier of products and services;
Granting of directed Discount by the Executor or the Organizer to each member of the Community, headed by the Executor or the Organizer, on products and services sold by the Supplier;
Delivering of products and services by the Supplier directly to each Customer (a member of the Community, headed by the Executor or the Organizer) for prices lowered for the amount of directed Discount;
Purchasing of products and services by each Customer (a member of the Community, headed Executor or the Organizer) from the Supplier directly for prices lowered for the amount of directed Discount;

In the present invention, the Organizer appoints or creates (by establishment of a legal entity) the Executor or several Executors;

In the present invention, there are two types of discounts in the market, namely: Overall Discount and Directed Discount, which are created by participants of the market, namely, the Organizer, the Executor, Suppliers and Customers of products and services;

In the present invention, the Organizer or the Executor initiate granting of Overall Discount from the Supplier of products and services who acts as Discounter and centrally provides Overall Discount to the Executor or the Organizer

In the present invention, the Organizer or the Executor initiate granting of Overall Discount and provide Directed Discount themselves to all Customers of products and services, who acts as Beneficiaries of Directed Discount;

In the present invention, the Organizer maybe represented by a person or legal entity, or a group of persons or legal entities;

In the present invention, the Organizer and the Executor maybe represented by the same person or the same group of persons or legal entities;

In the present invention, the Executor is a legal entity, for example:
If the Executor is an Association, a legal entity that does not gain profit, then Customers of products and services enter the Association and pay a single membership payment and regular payments, for example, monthly payments, for services on granting Directed Discount from the Executor to all members.
If the Executor is a Public Organization, a legal entity that does not gain profit, or a Commercial Company, then Customers of products and services sign partner agreements with the Public Organization or the Commercial Company for services on granting Directed Discount from the Executor to all Partners on certain products and services; and payment is made by Partners to the Executor for provided services.

In the present invention, Overall Discount centrally moves from the Supplier to the Executor or the Organizer, and Directed Discount moves from the Executor or the Organizer to each Customer (a member of the Community, headed by the Executor) of products and services, and, the size of Directed Discount is always less (in special cases it may be equal) than the size of Overall Discount;

### BRIEF DESCRIPTION OF THE DRAWINGS

FIG. 1 is an example 1 showing the structure of business processes using algorithms of discount system creation;

FIG. 2 is an example 2 showing the structure of business processes using algorithms of discount system creation;

### DESCRIPTION OF PREFFERED EMBODIMENT

Next, with reference to the accompanying drawings, a discount system creation business method according to an embodiment of the present invention will be described.

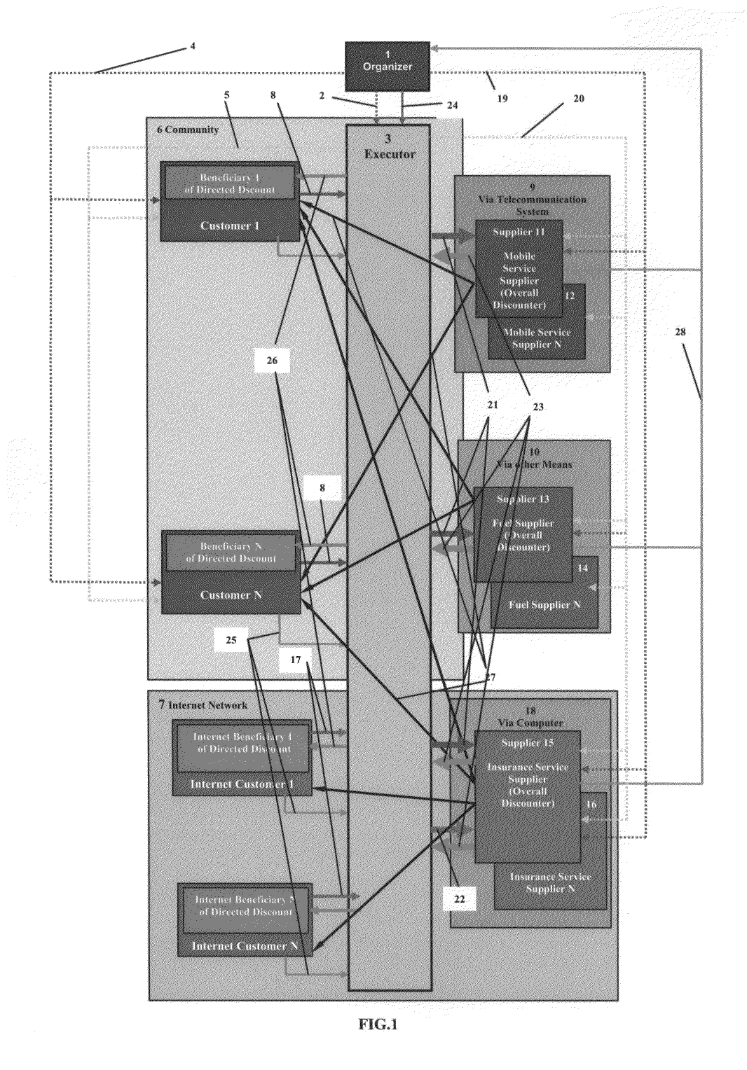

FIG. 1 is an example 1 showing the structure of business processes using algorithms of discount system creation business method according to an embodiment of the present invention: Organizer 1 appoints 2 (or creates by establishment of a legal entity) Executor 3; Organizer 1 (marked blue color) makes a request to 4 Customer 1—Customer N or Internet Customers 1—N, or Executor 3 makes the same request to 5 Customer 1—Customer N or Internet Customer 1—Customer N to be united in Community 6 or Network 7, headed by Executor 3. Uniting of 8, via telecommunication system 9 or other means 10, Customer 1—Customer N or Supplier 11—Supplier 16 into Community 6, headed by Executor 3. Uniting of 17, via computer 18, Internet Customer 1—Internet Customer N or Supplier 11—Supplier 16 into Network 7 headed by Executor 3. Organizer 1 (marked blue color) makes a request 19 to Supplier 11—Supplier 16, or Executor 3 makes the same request to 20 Supplier 11—Supplier 16 to grant Executor 3 overall Discount on sold products and services in exchange for turning Customer 1—Customer N (members of Community 6, headed by Executor 3) or Internet Customer 1—Internet Customer N (members of Network 7, headed by Executor 3) into clients of Suppliers. Customer 1—Customer N (members of Community 6, headed by Executor 3) become 21 clients of Suppliers 11,13,15; Internet Customer 1—Internet Customer N (members of Network 7, headed by Executor 3) become 22 clients of Suppliers 11,13,15; Suppliers 11,13,15 grant overall Discount 23 to Executor 3. Organizer 1 gives right 24 to Executor 3 to represent Organizer's interests 1 in dealing with Customers, and to grant Directed Discount to each Customer 1—Customer N or each Internet Customer 1—Internet Customer N. Customer 1—Customer N or Internet Customer 1—Internet Customer N make membership or regular payments (or payments for provided services) 25 to Executor 3 for services on granting discounts. Executor 3 grants Directed Discount 26 on sold products and services to each Customer 1—Customer N, members of Community 6, or each Internet Customer 1—Internet Customer N, members of Network 7. Suppliers 11,13,15 provide 27 products and services directly to each Customer 1—Customer N (members of Community 6, headed by Executor 3) or directly to each Internet Customer 1—Internet Customer N (members of Network 7, headed by Executor 3) for prices lowered on the amount of directed Discount. Customer 1—Customer N (members of Community 6, headed by Executor 3) or Internet Customer 1—Internet Customer N (members of Network 7, headed by Executor 3) purchase 27 products and services directly from Suppliers 11,13,15 for prices lowered on the amount of directed Discount. Suppliers 11,13,15 pay certain remuneration 28 to Organizer 1 for provided services on organizing a discount system which brings an increase in number of clients of Suppliers 11,13,15.

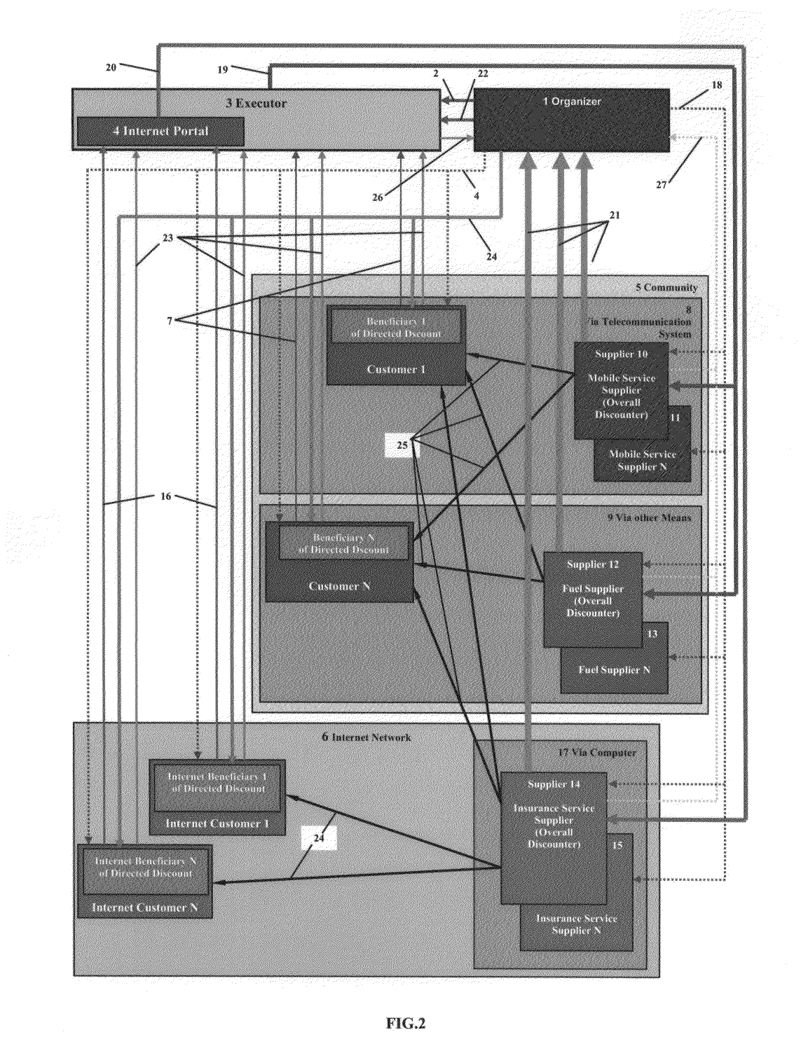

FIG. 2 is an example 2 showing the structure of business processes using algorithms of discount system creation business method according to an embodiment of the present invention: Organizer 1 appoints 2 (or creates by establishment of a legal entity) Executor 3; Organizer 1 (marked blue color) makes a request to 4 Customer 1—Customer N or Internet Customers 1—N, to be united in Community 6 or Network 7, headed by Executor 3. Uniting of 7, via telecommunication system 8 or other means 9, Customer 1—Customer N or Supplier 10—Supplier 15 into Community 6, headed by Executor 3. Uniting of 16, via computer 17, Internet Customer 1—Internet Customer N or Supplier 10—Supplier 15 into Network 7 headed by Executor 3. Organizer 1 (marked blue color) makes a request 18 to Supplier 10—Supplier 15 to grant him overall Discount on sold products and services in exchange for turning Customer 1—Customer N (members of Community 5, headed by Executor 3) or Internet Customer 1—Internet Customer N (members of Network 6, headed by Executor 3) into clients of Suppliers. Customer 1—Customer N (members of Community 5, headed by Executor 3) become 19 clients of Suppliers 10,12,14; Internet Customer 1—Internet Customer N (members of Network 6, headed by Executor 3) become 20 clients of Suppliers 10,12,14; Suppliers 10,12,14 grant overall Discount 21 to Organizer 1. Organizer 1 gives right 22 to Executor 3 to represent Organizer's interests 1 in dealing with Customer 1—Customer N or Internet Customer 1—Internet Customer N. Customer 1—Customer N or Internet Customer 1—Internet Customer N make membership or regular payments (or payments for provided services) 23 to Executor 3 for services on granting discounts. Organizer 1 grants Directed Discount 24 on sold products and services to each Customer 1—Customer N, members of Community 5, or each HRH Internet Customer 1—Internet Customer N, members of Network 6. Suppliers 10,12,14 provide 25 products and services directly to each Customer 1—Customer N (members of Community 5, headed by Executor 3) or directly to each Internet Customer 1—Internet Customer N (members of Network 6, headed by Executor 3) for prices lowered on the amount of directed Discount. Customer 1—Customer N (members of Community 5, headed by Executor 3) or Internet Customer 1—Internet Customer N (members of Network 6, headed by Executor 3) purchase 25 products and services directly from Suppliers 10,12,14 for prices lowered on the amount of directed Discount. Executor 3 pays certain remuneration 26 to Organizer 1 for granting directed Discount to Customer 1—Customer N or Internet Customer 1—Internet Customer N and receiving membership or regular payments (or payments for provided services) from them. Suppliers 10,12,14 pay certain remuneration 27 to Organizer 1 for provided services on organizing a discount system which brings an increase in number of clients of Suppliers 10,12,14.

What is claimed is:

1. A business method for discount system creation and marketing comprises the steps of: Assigning or creating (establishing) of the Executor (Executors) by the Organizer; Making requests on behalf of the Organizer or the Executor to the Customer or Customers of products or services with objective of being united in the Community headed by the Executor or the Organizer, and receiving directed Discount from the Executor or the Organizer on the purchased products and services; Uniting, via computer, telecommunication system or other means, Customers or Suppliers of products or services into the Community headed by the Executor or the Organizer, for example, association, public organization or other legal entities; Making requests on behalf of the Organizer or the Executor to the Supplier of products and services with objective of granting overall Discount to the Executor or the Organizer on the sold products and services in exchange for turning Customers (members of the Community, headed by the Executor or the Organizer) into clients of this Supplier; Turning of Customers (members of the Community, headed by the Executor or the Organizer) into clients of the Supplier which provides overall Discount to the Executor or the Organizer; Granting of overall Discount by the Supplier of products and services to the Executor or the Organizer on sold products and services; Turning of members of the Community, headed by the Executor or the Organizer, into clients of the given Supplier of products and services; Granting of directed Discount by the Executor or the Organizer to each member of the Community, headed by the Executor or the Organizer, on products and services sold by the Supplier; Delivering of products and services by the Supplier directly to each Customer (a member of the Community, headed by the Executor or the Organizer) for prices lowered for the amount of directed Discount; Purchasing of products and services by each Customer (a member of the Community, headed Executor or the Organizer) from the Supplier directly for prices lowered for the amount of directed Discount.
